(19) United States
(12) Patent Application Publication
(10) Pub. No.: US 2015/0035801 A1
(43) Pub. Date: Feb. 5, 2015

(54) GUIDE LIGHT TOUCH DEVICE WITH TOTAL INTERNAL REFLECTIVE DIFFRACTION LIGHT

(71) Applicant: Era Optoelectronics Inc., New Taipei City (TW)

(72) Inventor: CHIH-HSIUNG LIN, New Taipei City (TW)

(21) Appl. No.: 14/318,600

(22) Filed: Jun. 28, 2014

(30) Foreign Application Priority Data
Jul. 1, 2013 (TW) 102123419

(51) Int. Cl. G06F 3/042; F21V 8/00; G01B 11/14

(52) U.S. Cl. CPC G06F 3/0421; G01B 11/14; G02B 6/0011; G02B 6/0033
USPC 345/175

(57) ABSTRACT

A guide light plate touch device with total internal reflective diffraction light comprises a guide light plate, multiple light sensitive units, at least a light source, and a microprocessor; the light sensitive units sense the frustrated total internal reflective diffraction light and output a frustrated total internal reflection signal respectively; the microprocessor confirms at least two of the light sensitive units outputting the frustrated total internal reflection signal, calculates position information of the touch point based on position information of the at least two of the light sensitive lights, and outputs a corresponding touch signal; the light from the respective light sources can be irradiated to the diffraction unit or the guide light plate with a variable projecting angle such that the man hours for adjusting the projecting angle are saved greatly as well as the guide light plate without joining the optical coupler.

### CROSS-REFERENCE TO RELATED APPLICATIONS

The application claims priority from Taiwan Patent Application No. 102123419 filed on Jul. 1, 2013, the disclosure of which is incorporated herein by reference.

### BACKGROUND OF THE INVENTION

1. Field of the Invention

The present invention relates to a touch device, and, more particularly, to a touch device with which a state of frustrated total internal refection is sensed during light propagating in a guide light plate so as to generate a corresponding signal.

2. Description of Related Art

There are many touch devices in association with guide light plates; for instance, U.S. Pat. No. 7,432,893B2 discloses an input device based on frustrated total internal reflection in which lights emitting from two or more light sources are shot into a transparent plate to conduct total internal reflection and sensed by a light sensing array which is disposed to be opposite to the light sources and surround the peripheral side of the transparent; when an object touches the surface of the transparent plate, the total internal reflection of the lights in the guide light plate are frustrated, and every touch causes that the sensed signals of two or more lights propagating in the transparent plate attenuate to allow subsequent process capable of determining the touch position and touch area.

However, the lights emitting from the light sources taught in U.S. Pat. No. 7,432,893B2 have to shoot into the transparent plate with a specific projecting angle in order to allow the total internal reflection propagating in the transparent plate; to adjust the projecting angle needs a lot of man hours, and there is strict limit to the projecting angle as well.

Further, US Patent Application Publication No. 20130021302 discloses an optical coupler for use in an optical touch sensitive device in which the optical coupler is employed to join with the guide light plate for the light source and the sensor capable of being disposed in any directions with respect to the guide light plate.

But the optical coupler taught in US Patent Publication No. 20130021302 increases the weight and volume of the electronic product and it is incapable of meeting requirements of lightness, thinness, shortness and smallness for the electronic product.

### SUMMARY OF THE INVENTION

In order to improve the conventional touch device with total internal reflection propagating in a guide light plate, the present invention is proposed.

The primary object of the present invention is to provide a guide light plate touch device with total internal reflective diffraction light comprises a guide light plate, multiple light sensitive units, at least a light source, and a microprocessor; the multiple light sensitive units surround an area under the lowers surface of the guide light plate to form an operation zone; the microprocessor confirms at least two of the light sensitive units outputting the frustrated total internal reflective signal, calculates position information of the touch point based on position information of the at least two of the light sensitive lights, and outputs a corresponding touch signal.

Another object of the present invention is to provide a guide light plate touch device with total internal reflective diffraction light with which the diffraction light generated via the light emitting from the light sources irradiating the light diffracting unit or the guide light plate to propagate the total internal reflection in the guide light plate instead of the ordinary light being shot into the guide light plate to propagating the total internal reflection such that there is no restriction to the projecting angle of the light irradiating the light diffracting unit or the guide light plate in order to generate the diffraction light, and it is allowed that the projecting angle of the light from the respective light source is variable; therefore, a lot of man hours for adjusting the projecting angle can be saved, and, in addition, the guide light plate without joining the optical coupler is capable of meeting requirements of lightness, thinness, shortness and smallness needed by electronic products.

Further benefits and advantages of the present invention will become apparent after a careful reading of the detailed description with appropriate reference to the accompanying drawings.

### BRIEF DESCRIPTION OF THE DRAWINGS

FIG. 1 is a plan view illustrating a guide plate touch device with total internal reflective diffraction light in accordance with the present invention;

FIG. 2 is a bottom view illustrating a guide plate touch device with total internal reflective diffraction in accordance with the present invention.

### DETAILED DESCRIPTION OF THE INVENTION

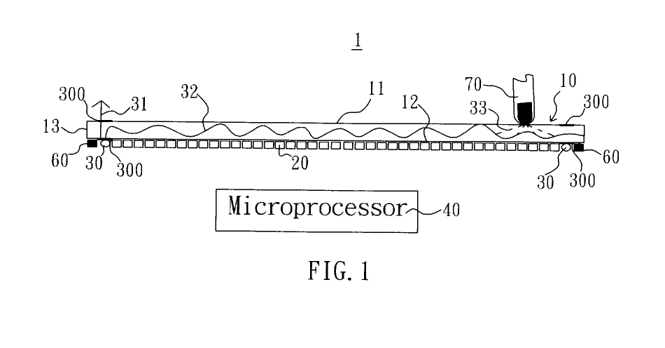

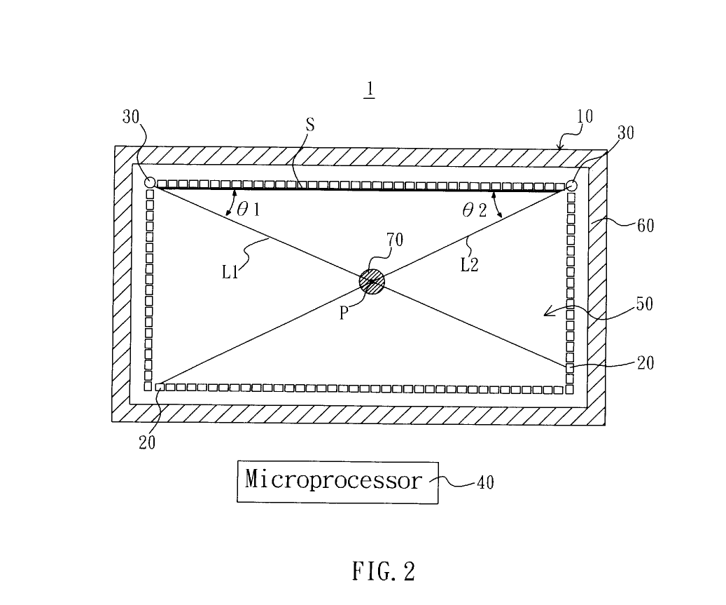

Referring to FIGS. 1 and 2, a guide plate touch device 1 with total internal reflective diffraction light according to the present invention comprises a guide light plate 10, multiple light sensitive units 20, at least two light sources 30, and a microprocessor 40; the guide light plate 10 is made of guide light material such as acrylic, resin or glass in a form of bendable or unbendable plate. The light sensitive units 20 can be photodiodes or any light sensitive components. The light sources 30 can be visible light or invisible light such as infrared LED light source or LASER source.

The guide light plate 10 has an upper surface 11 and a lower surface 12 which are parallel with each other, and a peripheral surface 13 is formed by lateral edges of the guide light plate 10. The multiple light sensitive units 20 and the at least two light sources 30 are electrically connected to the microprocessor 40.

The multiple light sensitive units 20 and at least two light sources 30 are disposed under the lower surface 12. The area surrounded by the multiple light sensitive units 20 forms an operation zone 50. The guide light plate 10 can be combined with a material capable of frustrating total internal reflection to form a frustrating total internal reflection zone 60 corresponding to an area surrounding the operation zone 50, and it is convenient for the user to touch the zone 60 and pick up the device without generating the touch signal.

At least one of positions on the upper and lower surfaces 11, 12 corresponding to the lights 31 of the light sources 30 irradiating the guide light plate 10 is further disposed with a light diffraction unit 300. The light diffraction unit 300 can be a grating film capable of increasing diffraction intensity, etched diffraction lines (on the guide light plate 10) or plated film to enhance intensity of a diffraction light 32 generated by the light 31 issued by the light sources 30.

It is shown in FIGS. 1 and 2 that there are at least two light sources 30 which emit lights 31 with a modulation signal respectively to irradiate the light diffraction unit 300 and the guide light plate 10 sequentially; majorities of the lights 31 pass through both the light diffraction unit 300 and the guide light plate 10 and minorities of the lights 31 generate the diffraction light 32 to propagate the total internal reflection between the upper surface 11 and lower surface 12 and shoot the multiple light sensitive units 20 instead of passing through the guide light plate 10. The modulation signal can be a frequency signal, amplitude signal, or phase signal of the respective light 31. The respective light 31 can be the ordinary light without the modulation signal.

When an object 70 is not to touch the upper surface 11 of the guide light plate 10 within the operation zone 50, the multiple sensitive units 20 sense non-frustrated total internal reflective signals during the diffraction light 32 processing the total internal reflection in the guide light plate 10.

As shown in FIGS. 1 and 2, when the object 70 such as a finger is in the operation zone to touch the upper surface 11 of the guide light plate 10, the diffraction light 32 is reflected by the object 70 as a frustrated total internal reflective diffraction light 33. Hence, the diffraction light 32, which is on a line connecting the respective light source 30, the object 70 and the respective light sensitive units 20, is changed to or damaged as the frustrated total internal reflective diffraction light 33; when the respective light sensitive unit 20 senses the corresponding frustrated total internal reflective diffraction light 33, a frustrated total internal reflective signal is output.

The microprocessor 40 is employed to detect and compare the output signals of the multiple light sensitive units 20, confirms both the major non-frustrated total internal reflective signals and the minor frustrated total internal reflective signals, and determine the light sensitive units 20 outputting the frustrated total internal reflective signals.

As shown in FIG. 2 again, one of the two light sources 30, the object 70 corresponding to said light source 30 irradiating the light diffraction unit or the guide light plate 10 to generate the frustrated total internal reflective diffraction light, and one of the light sensitive units 20 sensing the frustrated total internal reflective signal are connected with a line L1; another light source 30, the object 70 corresponding to said another light source 30 irradiating the light diffraction unit or the guide light plate 10 to generate the frustrated total internal reflective diffraction light, and another one of the light sensitive units 20 sensing the frustrated total internal reflective signal can be connected with another line L2. The intersection of lines L1 and L2 is a touch point P that the object 70 touches the guide light plate 10.

As further shown in FIG. 2, the two light sources 30 and the touch point P form a triangle. A connection line S between the two light sources 30 and angles θ1,θ2 respectively between the connection line S and the line L1 and between the connection line S and the line L2 in association with the known trigonometric formulas are capable of being used to figure out coordinates of the touch point P. Wherein, the angles θ1,θ2 correspond to positions of the two light sensitive units 20 sensing the frustrated total internal reflective signals and the position of connection line S between the two light sources 30 respectively. Hence, the microprocessor 40 can figure out position information of the touch point P and output a corresponding touch signal based on confirming the light sensitive units 20 outputting the frustrated total internal reflective signals and according to position information of the two light sources 30 and the diffraction lights emitted sequentially by the two light sources 30 to sense position information of the two light sensitive units 20 which output the frustrated total internal reflective signals.

Application Ser. No. 14/249,552 filed by the present inventor on Apr. 10, 2014, which is corresponding to Taiwan Patent Application No. 102113220 filed on Apr. 15, 2013, is characterized by that only a light source with diffraction light is reflected by peripheral surface of the light guide plate; the characteristic of application Ser. No. 14/249,552 can be applied to the present invention as well, and the microprocessor is employed to confirm at least two light sensitive units which output the frustrated total internal reflective signal, calculate the position information of the touch point, and output a corresponding touch signal in accordance with the position information of the two sensitive units.

The present invention is characterized by that the lights emitting from the light sources irradiate the light diffracting unit or the guide light plate to generate the diffraction light which then propagates between the upper and lower surfaces of the guide light plate to shoot multiple light sensitive units; when an object touches the upper surface of the guide light plate, the diffraction light is reflected by the object as the frustrated total internal reflective diffraction light; the light sensitive units sense the frustrated total internal reflective diffraction light and output a frustrated total internal reflective signal; the microprocessor is employed to confirm at least two of the light sensitive units which output the frustrated total internal reflection signal, calculate the position information of the touch point based on the position information of the at least two of the light sensitive units, and output a corresponding touch signal.

Due to the diffraction light generated via the lights emitting from the light sources irradiating the light diffracting unit or the guide light plate to propagate the frustrated total internal reflection between the upper and lower surfaces of the guide light plate instead of the ordinary light being shot into the guide light plate to propagate the frustrated total internal reflection, there is no restriction to what the projecting angle is while the lights from the light sources irradiate the light diffracting unit or the guide light plate to generate the diffraction light, that is, the projecting angle of the light from the respective light sources can be variable, and, under the circumferences, the man hours for adjusting the projecting angle can be saved greatly.

It is appreciated that the guide light plate of the present invention is not joined to an optical coupler to meet requirements of lightness, thinness, shortness, and smallness for electronic products; in addition, it is not necessary for the light emitted by the light source to shoot into the optical coupler or the guide light plate with an accurate projecting angle in order to propagate the total internal reflection in the guide light plate such that the conventional guide light plate touch device is further improved effectively.

Although the invention has been described in relation to its preferred embodiment, it is to be understood that many other possible modifications and variations can be made without departing from the spirit and scope of the invention as hereinafter claimed.

What is claimed is:

1. A guide light plate touch device with total internal reflective diffraction light, comprising:
a guide light plate having an upper surface and a lower surface being parallel with each other;
a microprocessor;
a plurality of light sensitive units electrically connecting with said microprocessor;
at least a light source electrically connecting with said microprocessor;
wherein the light sensitive units and said light source are arranged under the lower surface of the guide light plate; an area is surrounded by the light sensitive units to form an operation zone; when said light source emits light to irradiate the guide light plate and generate diffraction light, the diffraction light propagates total internal reflection between the upper and lower surfaces to shoot the light sensitive units which further output non-frustrated total internal reflection signals; when an object touches a touch point on the upper surface, said diffraction light is reflected by the object and becomes frustrated total internal reflective diffraction light; the light sensitive units sense the frustrated total internal reflective diffraction light and output a frustrated total internal reflection signal respectively; the microprocessor confirms at least two of the light sensitive units which output the frustrated total internal reflection signal, calculates position information of said touch point based on position information of the at least two of the light sensitive lights, and outputs a corresponding touch signal.

2. The guide light plate touch device with total internal reflective diffraction light as defined in claim 1 further comprising at least two light sources.

3. The guide light plate touch device with total internal reflective diffraction light as defined in claim 1, wherein the upper and lower surfaces of the guide light plate have positions corresponding to lights emitting from the light sources irradiating on the guide light plate, and one of the positions further comprising a light diffraction unit to enhance intensity of the diffraction light.

4. The guide light plate touch device with total internal reflective diffraction light as defined in claim 3, wherein the guide light plate is made of glass; said light diffraction unit is a grating film, etched diffraction lines or a plated film.

5. The guide light plate touch device with total internal reflective diffraction light as defined in claim 3, wherein the guide light plate is made of guide light material in a form of bendable or unbendable plate; said light diffraction unit is a grating film, etched diffraction lines or a plated film.

6. The guide light plate touch device with total internal reflective diffraction light as defined in claim 4, wherein the light sensitive units are photodiodes; the light sources are LED light sources or LASER sources.

7. The guide light plate touch device with total internal reflective diffraction light as defined in claim 5, wherein the light sensitive units are photodiodes; the light sources are LED light sources or LASER sources.

8. The guide light plate touch device with total internal reflective diffraction light as defined in claim 6, wherein the guide light plate combines with a material capable of frustrating total internal reflection of the light to form a frustrating total internal reflection zone corresponding to an area surrounding the operation zone.

9. The guide light plate touch device with total internal reflective diffraction light as defined in claim 7, wherein the guide light plate combines with a material capable of frustrating total internal reflection of the light to form a frustrating total internal reflection zone corresponding to an area surrounding the operation zone.

10. The guide light plate touch device with total internal reflective diffraction light as defined in claim 2, wherein the upper and lower surfaces of the guide light plate have positions corresponding to lights emitting from the light sources irradiating on the guide light plate, and one of the positions further comprising a light diffraction unit to enhance intensity of the diffraction light.

11. The guide light plate touch device with total internal reflective diffraction light as defined in claim 10, wherein the guide light plate is made of glass; said light diffraction unit is a grating film, etched diffraction lines or a plated film.

12. The guide light plate touch device with total internal reflective diffraction light as defined in claim 10, wherein the guide light plate is made of guide light material in a form of bendable or unbendable plate; said light diffraction unit is a grating film, etched diffraction lines or a plated film.

13. The guide light plate touch device with total internal reflective diffraction light as defined in claim 11, wherein the light sensitive units are photodiodes; the light sources are LED light sources or LASER sources.

14. The guide light plate touch device with total internal reflective diffraction light as defined in claim 12, wherein the light sensitive units are photodiodes; the light sources are LED light sources or LASER sources.

15. The guide light plate touch device with total internal reflective diffraction light as defined in claim 13, wherein the guide light plate combines with a material capable of frustrating total internal reflection of the light to form a frustrating total internal reflection zone corresponding to an area surrounding the operation zone.

16. The guide light plate touch device with total internal reflective diffraction light as defined in claim 14, wherein the guide light plate combines with a material capable of frustrating total internal reflection of the light to form a frustrating total internal reflection zone corresponding to an area surrounding the operation zone.
